(19) United States
(12) Patent Application Publication
(10) Pub. No.: US 2026/0149372 A1
(43) Pub. Date: May 28, 2026

(54) CURRENT MODE CONTROLLER

(71) Applicant: Renesas Design Technology Inc., San Jose, CA (US)

(72) Inventors: Oleksii ANISIMOV, Lviv (UA); Yaroslav BRIUKHOVETSKYI, Lviv (UA)

(73) Assignee: Renesas Design Technology Inc., San Jose, CA (US)

(21) Appl. No.: 18/959,876

(22) Filed: Nov. 26, 2024

(51) Int. Cl. H02M 3/156; H02M 1/00; H02M 1/088

(52) U.S. Cl. CPC H02M 3/156; H02M 1/0009; H02M 1/088

(57) ABSTRACT

A current mode controller for a switching converter is provided. The controller includes an error voltage generator for generating an error voltage dependent on an output voltage and a reference voltage; a current sensing module; an error amplifier; and a control signal generator. The current sensing module senses a current flowing through an energy storage element, receives the error voltage, and generates a slope compensated sensed current signal dependent on the sensed current and the error voltage. The error amplifier receives the error voltage, generates an amplified voltage error signal by applying a first amplification coefficient dependent on the error voltage to the error voltage. The control signal generator generates one or more control signals to control the switching operation of one or more power switches of the switching converter, each of the control signals being dependent on the slope compensated sensed current signal and the amplified voltage error signal.

The present disclosure relates to a current mode controller for a switching converter.

### BACKGROUND

Current mode control is a commonly used control method for switched-mode power supplies (SMPS).

Compared to the voltage control method, current mode control has a high frequency bandwidth, which results in improved control loop dynamics and leads to a better line noise rejection, by reducing the small-signal dynamics from second-order to first-order. This simplifies the design of the feedback circuit.

The current control method can be classified into average current mode and peak current mode. As the name suggests, the average current mode control adjusts the average current of the inductor. Peak current mode is a control technique where the duty cycle is terminated when the inductor current reaches a threshold level determined by an external voltage controller.

### SUMMARY

It is desirable to provide an improved current mode controller for a switching converter, when compared with known systems.

According to a first aspect of the disclosure there is provided a current mode controller for a switching converter comprising one or more power switches, an energy storage element, and being configured to receive an input voltage and to generate an output voltage, the current mode controller comprising an error voltage generator configured to generate an error voltage that is dependent on the output voltage and a reference voltage, a current sensing module configured to sense a current that is flowing through the energy storage element, receive the error voltage, and generate a slope compensated sensed current signal that is dependent on the sensed current and the error voltage, an error amplifier configured to receive the error voltage, generate an amplified voltage error signal by applying a first amplification coefficient to the error voltage, the first amplification coefficient being dependent on the error voltage, and a control signal generator configured to generate one or more control signals to control the switching operation of the one or more power switches of the switching converter, each of the one or more control signals being dependent on the slope compensated sensed current signal and the amplified voltage error signal.

Optionally, the energy storage element comprises an inductor.

Optionally, the current mode controller is configured to provide peak current control.

Optionally, the error voltage generator comprises a subtractor circuit configured to generate the error voltage by subtracting the reference voltage from the output voltage or by subtracting the output voltage from the reference voltage.

Optionally, the current sensing module comprises a current sensing amplifier configured to sense the current that is flowing through the energy storage element, and generate an amplified sensed current signal by applying a second amplification coefficient to the sensed current, wherein the slope compensated sensed current signal is dependent on the amplified sensed current signal, thereby being dependent on the sensed current.

Optionally, the current sensing module comprises a slope generation module configured to receive the error voltage, and generate a slope compensation signal that is dependent on the error voltage, wherein the slope compensated sensed current signal is dependent on the slope compensation signal, thereby being dependent on the error voltage.

Optionally, the energy storage element comprises an inductor, and the slope compensation signal is dependent on i) a differential inductor voltage, ii) the second amplification coefficient, iii) the inductance of the inductor, iv) a current rise time, and v) a dynamic duty cycle that is dependent on the reference voltage, the input voltage and the error voltage.

Optionally, the current sensing module comprises an addition circuit configured to generate the slope compensated sensed current signal by adding the slope compensation signal and the amplified sensed current signal, and provide the slope compensated sensed current signal to the control signal generator.

Optionally, the slope compensation signal is added to the amplified sensed current signal by adding a bias current to the amplified sensed current signal.

Optionally, the error amplifier comprises dynamic gain module configured to receive the error voltage, and generate the first amplification coefficient using the error voltage.

Optionally, the energy storage element comprises an inductor, and the first amplification coefficient is dependent on i) a differential inductor voltage, and ii) a dynamic duty cycle that is dependent on the reference voltage, the input voltage and the error voltage.

Optionally, the error amplifier comprises a voltage error amplifier module configured to receive the error voltage, receive the first amplification coefficient from the dynamic gain module, and generate the amplified voltage error signal by applying the first amplification coefficient to the error voltage.

Optionally, the control signal generator comprises a comparator configured to receive the slope compensated sensed current signal at a first input terminal, receive the amplified voltage error signal at a second input terminal, generate a comparator output signal at an output terminal, the comparator output signal being dependent on the comparison between the sensed current signal and the amplified voltage error signal, and a pulse width modulator circuit configured to receive the comparator output signal, and generate the one or more control signals using the comparator output signal.

Optionally, a duty cycle is approximately equal to the reference voltage divided by the input voltage, for the duty cycle being greater than or approximately equal to 50% the current sensing module is configured to sense the current that is flowing through the energy storage element, receive the error voltage, and generate the slope compensated sensed current signal that is dependent on the sensed current and the error voltage, the control signal generator is configured to generate the one or more control signals to control the switching operation of the one or more power switches of the switching converter, each of the one or more control signals being dependent on the slope compensated sensed current signal and the amplified voltage error signal, and for the duty cycle being less than 50% the current sensing module is configured to sense the current that is flowing through the energy storage element, generate a sensed current signal that is dependent on the sensed current, and the control signal generator is configured to generate the one or more control signals to control the switching operation of the one or more power switches of the switching converter, each of the one or more control signals being dependent on the sensed current signal.

Optionally, the switching converter is a buck converter, a boost converter or a buck-boost converter.

According to a second aspect of the disclosure there is provided a switched-mode power supply comprising a switching converter configured to receive an input voltage and to generate an output voltage, the switching converter comprising one or more power switches, an energy storage element, and a current mode controller comprising an error voltage generator configured to generate an error voltage that is dependent on the output voltage and a reference voltage, a current sensing module configured to sense a current that is flowing through the energy storage element, receive the error voltage, and generate a slope compensated sensed current signal that is dependent on the sensed current and the error voltage, an error amplifier configured to receive the error voltage, generate an amplified voltage error signal by applying a first amplification coefficient to the error voltage, the first amplification coefficient being dependent on the error voltage, and a control signal generator configured to generate one or more control signals to control the switching operation of the one or more power switches of the switching converter, each of the one or more control signals being dependent on the slope compensated sensed current signal and the amplified voltage error signal.

Optionally, the energy storage element comprises an inductor.

Optionally, the current mode controller is configured to provide peak current control.

Optionally, the switching converter is a buck converter, a boost converter or a buck-boost converter.

It will be appreciated that the switched-mode power supply of the second aspect may include features set out in relation to the first aspect and/or may include other features as described herein.

According to a third aspect of the disclosure there is provided a method of controlling a switching converter comprising one or more power switches, an energy storage element, and being configured to receive an input voltage and to generate an output voltage, the method comprising generating an error voltage that is dependent on the output voltage and a reference voltage, using an error voltage generator, sensing a current that is flowing through the energy storage element using a current sensing module, receiving the error voltage at the current sensing module, generating a slope compensated sensed current signal that is dependent on the sensed current and the error voltage using the current sensing module, receiving the error voltage at an error amplifier, generating an amplified voltage error signal by applying a first amplification coefficient to the error voltage using the error amplifier, the first amplification coefficient being dependent on the error voltage, and generating one or more control signals using a control signal generator, each of the one or more control signals being dependent on the slope compensated sensed current signal and the amplified voltage error signal, and controlling the switching operation of the one or more power switches using the one or more control signals.

It will be appreciated that the method of the third aspect may include providing and/or using features set out in the first and/or second aspect and can incorporate other features as described herein.

### BRIEF DESCRIPTION OF THE DRAWINGS

The disclosure is described in further detail below by way of example and with reference to the accompanying drawings, in which:

FIG. 1 shows a graph of the inductor current as it varies with time for a practical implementation of a switching converter operating with a duty cycle greater than 50%, and a graph of the inductor current as it varies with time for a practical implementation of the switching converter operating with a duty cycle less than 50%;

FIG. 2 is a timing graph showing simulation results for a practical implementation of a buck converter with slope compensation and a practical implementation of a buck converter without slope compensation;

FIG. 3 is a schematic of a known switch mode power supply;

FIG. 4 is a schematic of a switch mode power supply comprising a dynamic slope module to provide dynamic slope compensation;

FIG. 5 is a schematic of a current mode controller and a switching converter, in accordance with a first embodiment of the present disclosure;

FIG. 6 is a schematic of a specific embodiment of the current mode controller and a specific embodiment of the switching converter of FIG. 5, in accordance with a second embodiment of the present disclosure;

FIG. 7 is a timing graph showing simulation results for practical implementations of pulsed power supplies;

FIG. 8 is a further timing graph showing simulation results for practical implementations of pulsed power supplies; and

FIG. 9 is a schematic of a specific embodiment of the dynamic gain module.

### DETAILED DESCRIPTION

Peak current mode control has advantages over other control methods, such as simple cycle-to-cycle current limiting and good current sharing in a multiphase system. That said, there are several disadvantages of peak current control. For example, the control may become unstable if the duty cycle exceeds 50%, leading to subharmonic oscillations sensitivity to noise, especially for small inductor current ripples.

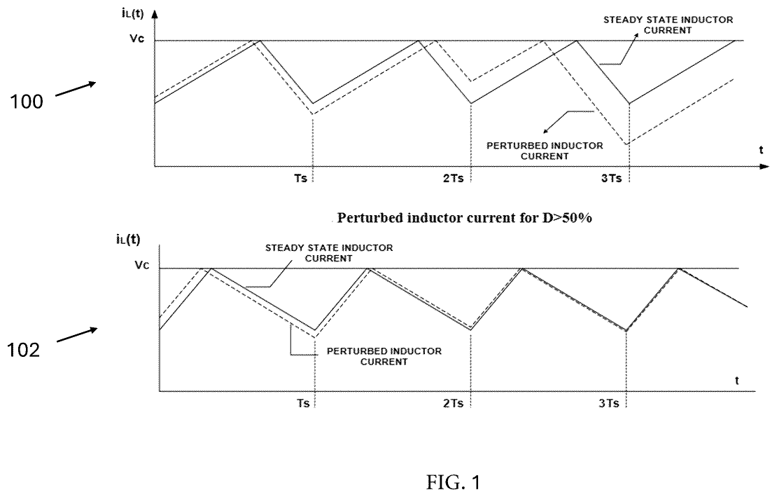

FIG. 1 shows a graph 100 of the inductor current as it varies with time for a practical implementation of a switching converter operating with a duty cycle greater than 50%, and a graph 102 of the inductor current as it varies with time for a practical implementation of the switching converter operating with a duty cycle less than 50% (Raghavan Sampath, Digital Peak Current Mode Control of Buck Converter Using MC56F8257 DSC, Document Number: AN4716, Freescale Semiconductor, Inc., 2013).

The examples presented in FIG. 1 relate to a peak current mode controlled switching converter using a continuous conduction mode (CCM). The inductor current may transition to sub-harmonic oscillations depending on the operating conditions. For example, perturbations in the inductor current (for example due to fluctuations in a control voltage) persist when the duty cycle exceeds 50%, as shown in the graph 100 where the inductor current moves away from the steady state inductor current profile with each switching cycle. Perturbations in the inductor current diminish with each switching cycle when the duty cycle is less than 50%.

A common approach to restoring stability is to apply slope compensation in peak current controlled converters with duty cycles above 50%. One drawback is that the saw peak current control method produces an error in the output voltage relative to the reference voltage.

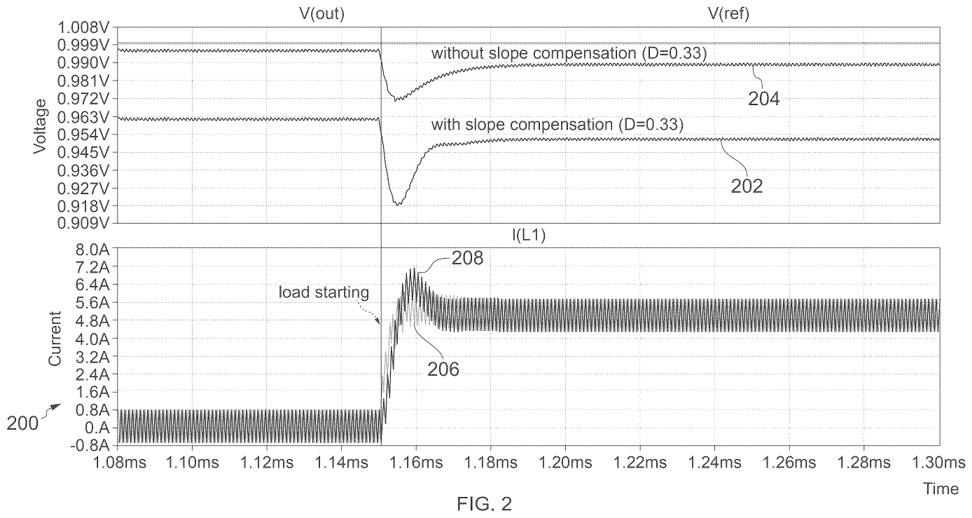

FIG. 2 is a timing graph 200 showing simulation results for a practical implementation of a buck converter with slope compensation and a practical implementation of a buck converter without slope compensation. In both examples the duty cycle is 33%.

The following traces are shown on the timing graph: an output voltage of the buck converter with slope compensation (a trace 202), an output voltage of the buck converter without slope compensation (a trace 204), an inductor current of the buck converter with slope compensation (a trace 206), and an inductor current of the buck converter without slope compensation (a trace 208).

For a larger output current, there is a larger error. The magnitude of this error can be reduced by increasing the loop gain of the switching converter, but this will lead to a decrease in system stability. Another disadvantage is that when stabilizing the system using the slope compensation method, the error of the output voltage relative to the reference voltage increases proportionally to the slope compensation value.

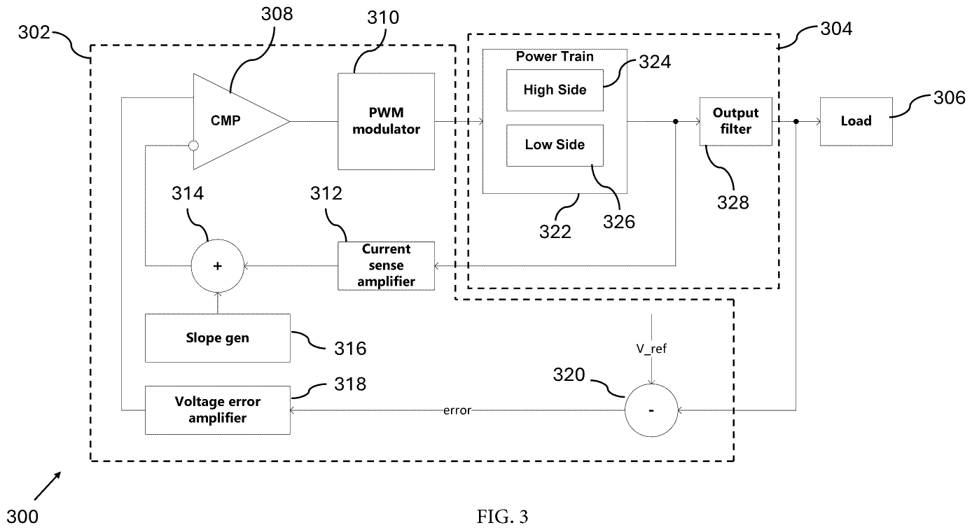

FIG. 3 is a schematic of a known switch mode power supply 300 comprising a current mode controller 302 and a switching converter 304 coupled to a load 306. The current mode controller 302 comprises a comparator 308, a PWM modulator 310, a current sense amplifier 312, and addition circuit 314, a slope generator 316, a voltage error amplifier 318 and an addition circuit 320. The switching converter 304 comprises a power train 322 comprising a high side switch 324 and a low side switch 326, and an output filter 328.

The switch mode power supply 300 uses slope compensation. The control loop includes two main feedback signals: the first feedback signal is a voltage error signal, which represents the difference between the sensed output voltage and reference voltage; and the second feedback signal is the sensed output current of the power train 322. For duty cycles less than 50%, the first and second feedback signals are input directly to the control block, which determines the duty cycle needed to maintain output voltage regulation. However, for duty cycles greater than 50%, slope compensation is implemented. A bias current is added to the sensed output current of the power train 322. The amount of bias current is determined by the current slope generator 316. The slope of the bias current remains constant over the entire operating range. Although this method is effective in avoiding sub-harmonic oscillations maintaining loop stability, the disadvantages include increased output voltage error and poor dynamic load response.

A generally known calculation formula for slope compensation, considering a differential inductor voltage Vl is as follows:

$$V ( ton ) = \frac{Vl \times Ksense}{L} \times \frac{D}{1 - D} \times ton \qquad ( 1 )$$

where Ksense is a transformation coefficient for inductor current to voltage conversion, L is the inductance of the inductor of the switching converter, D is the duty cycle and ton is the current rise time.

V(ton) is the slope compensation voltage as a function of ton. For dead-beat control, the slope compensation voltage V(ton) is set to the slope of the de-magnetizing phase of the inductor current.

The current rise time ton is as follows:

$$ton = D \times T s w \qquad ( 2 )$$

where Tsw is the switching period.

The duty cycle D for a switching converter using continuous conduction mode (CCM) may be calculated as follows:

$$D = \frac{Vref}{Vin} \qquad ( 3 )$$

where Vref is a reference voltage and Vin is the input voltage.

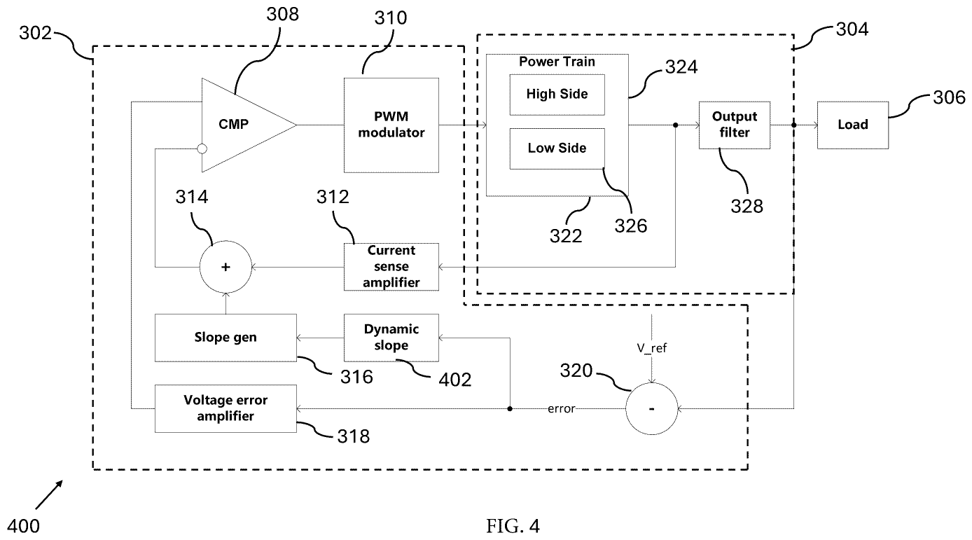

FIG. 4 is a schematic of a switch mode power supply 400 comprising a dynamic slope module 402 to provide dynamic slope compensation. The dynamic slope module 402 adjusts the bias current added to the sensed output current of the power train 322 based on the voltage error signal.

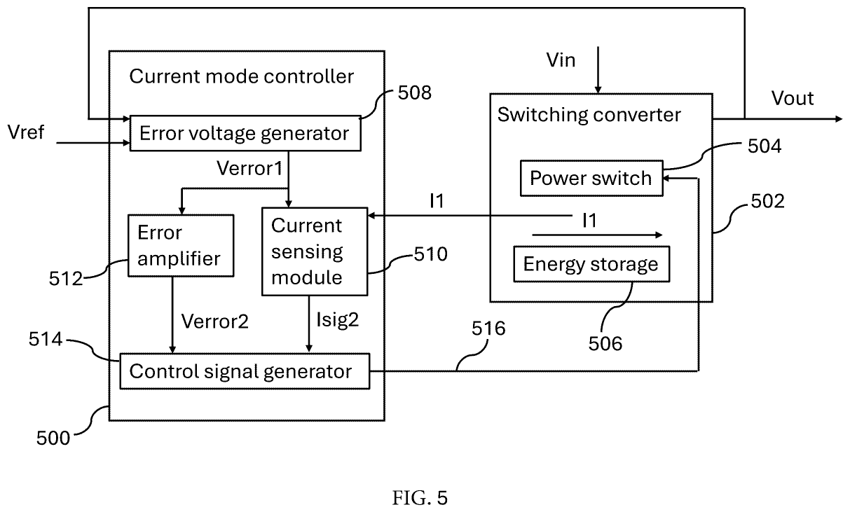

FIG. 5 is a schematic of a current mode controller 500 and a switching converter 502, in accordance with a first embodiment of the present disclosure. The current mode controller 500 and the switching converter 502 may form a switched-mode power supply.

The switching converter 502 comprises one or more power switches. In the present embodiment, the switching converter 502 comprises a power switch 504. The switching converter 502 further comprises an energy storage element 506, which may, for example, comprise an inductor. The switching converter 502 may, for example be a buck converter, a boost converter or a buck-boost converter.

Each of the one or more power switches 504 may comprise a transistor, such as a metal oxide semiconductor field effect transistor (MOSFET). For each power switch 504, the MOSFET may be p-type or n-type in accordance with the understanding of the skilled person.

During operation, the switching converter 502 receives an input voltage Vin and generates an output voltage Vout, with the output voltage Vout being generated as a result of the switching of the one or more power switches 504, as controlled by the current mode controller 500. The current mode controller 500 may provide peak current control.

The current mode controller 500 comprises an error voltage generator 508 configured to generate an error voltage Verror that is dependent on the output voltage Vout and a reference voltage Vref.

The current mode controller 500 further comprises a current sensing module 510 that is configured to receive the error voltage Verror1. During operation, the current sensing module 510 senses a current I1 flowing through the energy storage element 506.

The current sensing module 510 then generates a slope compensated sensed current signal Isig2 that is dependent on the sensed current I1 and the error voltage Verror1.

The current mode controller 500 further comprises an error amplifier 512 that is configured to receive the error voltage Verror1 and to generate an amplified voltage error signal Verror2 by applying a first amplification coefficient to the error voltage Verror1. The first amplification coefficient is dependent on the error voltage Verror1.

The current mode controller 500 further comprises a control signal generator 514 that configured to generate one or more control signals to control the switching operation of the one or more power switches of the switching converter 502. Each of the one or more control signals is dependent on the slope compensated sensed current signal Isig2 and the amplified voltage error signal Verror2.

In the present example, the control signal generator 514 generates a control signal 516 to control the switching operation of the switch 504.

Each of the one or more control signals may be a digital signal that switches between a high state and a low state. A digital control signal being provided to a switch may result in the switching of the switch. For example, when the digital signal in a high state is provided to the switch, the switch may be turned to an “on state” where current flow is permitted, and when the digital signal in a low state is provided to the switch, the switch may be turned to an “off state” where current flow is prevented. Through such a switching operation, the energy storage element 506 may be repeatedly coupled to and decoupled from a power source (for example as provided by an input voltage Vin), which results in the generation of the output voltage Vout.

Each of the control signals may be provided via a gate driver configured to set the voltage as provided to the switch to a suitable level for controlling the switching operation of the switch.

It will be appreciated that other switching converter 502 control schemes may be performed, in accordance with the understanding of the skilled person.

During operation, the current mode controller 500 may provide both dynamic slope compensation and dynamic gain control.

Dynamic slope compensation may be provided by the current sensing module 510 which provides the slope compensated current signal Isig2 that is dependent on the error voltage Verror1 in addition to the sensed current I1. Based on the value of the output voltage error Verror1, the current sensing module 510 dynamically adjusts the slope compensation curve. This improves voltage regulation and dynamic load response.

Dynamic gain control may be provided by the error amplifier 512 where the gain of the error amplifier 512 provided by the first amplification coefficient has a dependency on the error voltage Verror1.

Based on the value of the output voltage error Verror1, the error amplifier 512 adjusts the gain of the voltage error amplifier 512. This further improves voltage regulation and dynamic load response.

For a specific embodiment of the current mode controller 500 and the switching converter 502, the duty cycle may be determined using equation (3). Dynamic slope compensation may be provided by the current mode controller 500 when operating with a duty cycle that is greater than 50%. Dynamic slope compensation may not be provided by the current mode controller 500 when operating with a duty cycle that is less than 50%. For example, when the duty cycle is less than 50%, the current sensing module 510 may sense the current I1 and generated a sensed current signal that is dependent on the sensed current I1, and has no dependency on the error voltage Verror1. The control signal generator 514 then generates the one or more control signals 516 that are dependent on the uncompensated sensed current signal.

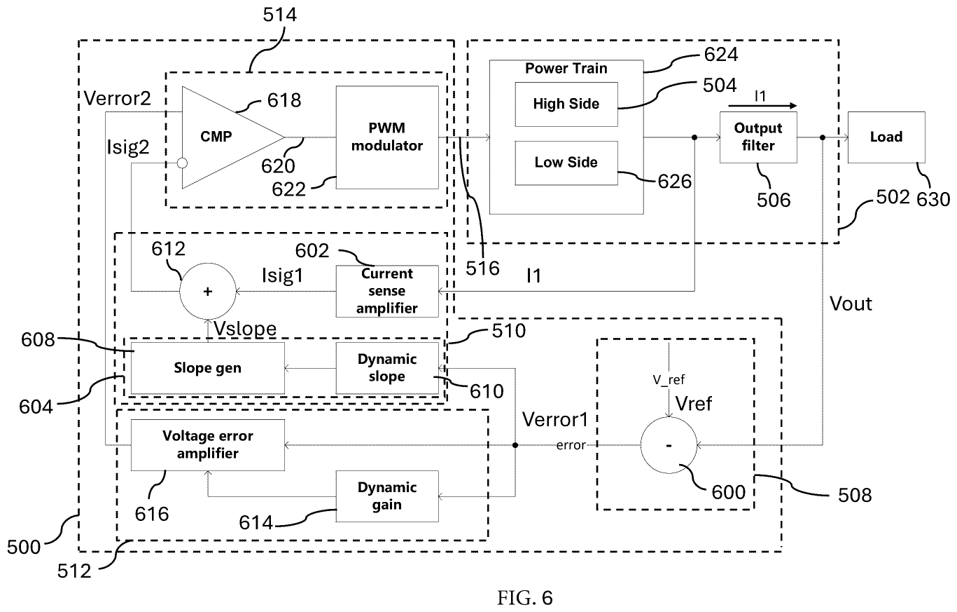

FIG. 6 is a schematic of a specific embodiment of the current mode controller 500 and a specific embodiment of the switching converter 502, in accordance with a second embodiment of the present disclosure.

The error voltage generator 508 may comprise a subtractor circuit 600 that is configured to generate the error voltage Verror1 by subtracting the reference voltage Vref from the output voltage Vout, or by subtracting the output voltage Vout from the reference voltage Vref.

The current sensing module 510 may comprise a current sensing amplifier 602. During operation, the current sensing amplifier 602 senses the current I1 that is flowing through the energy storage element 506 and generates an amplified sensed current signal Isig1 by applying a second amplification coefficient to the sensed current I1. The slope compensated sensed current signal Isig2 is dependent on the amplified sensed current signal Isig1 and is therefore dependent on the sensed current I1.

The current sensing module 510 may further comprise a slope generation module 604 configured to receive the error voltage Verror1 and generate a slope compensation signal Vslope that is dependent on the error voltage Verror1. The slope compensated sensed current signal Isig2 is dependent on the slope compensation signal Vslope, thereby being dependent on the error voltage Verror1.

The slope generation module 604 may comprise a slope generator 608 and a dynamic slope module 610 to provide dynamic slope compensation. The slope generator 608 and the dynamic slope module 610 may function substantially as described for the slope generator 316 and the dynamic slope module 402, respectively, in accordance with the understanding of the skilled person.

The current sensing module 510 may further comprise an addition circuit 612. During operation, the addition circuit 612 may generate the slope compensated sensed current signal Isig2 by adding the slope compensation signal Vslope and the amplified sensed current signal Isig1 together. The addition circuit 612 may then provide the slope compensated sensed current signal Isig2 to the control signal generator 514. The slope compensation signal Vslope may be added to the amplified sensed current signal Isig1 by adding a bias current to the amplified sensed current signal Isig1.

The error amplifier 512 may comprise a dynamic gain module 614 that is configured to receive the error voltage Verror1 and generate the first amplification coefficient using the error voltage Verror1.

The error amplifier 512 may further comprise a voltage error amplifier module 616 that is configured to receive the error voltage Verror1, receive the first amplification coefficient, and generate the amplified voltage error signal Verror2 by applying the first amplification coefficient to the error voltage Verror1.

The control signal generator 514 may comprise a comparator 618 that is configured to receive the slope compensated sensed current signal Isig2 at a first input terminal and receive the amplified voltage error signal Verror2 at a second input terminal. The comparator 618 is further configured to generate a comparator output signal 620 at an output terminal, with the comparator output signal 620 being dependent on the comparison between the compensated sensed current signal Isig2 and the amplified voltage error signal Verror2.

The control signal generator 514 may further comprise a pulse width modulation circuit 622 configured to receive the comparator output signal 620 and to generate the one or more control signals 516 using the comparator output signal 620.

The switching converter 502 may comprise a power train 624 comprising the switch 504 and a switch 626. The switch 504 may be a high side switch and the switch 626 may be a low side switch. The switching converter 502 comprises the energy storage element 506 coupled to a load 630. The energy storage element 506 may comprise an inductor. The energy storage element 506 may be referred to as an “output filter”.

The slope compensation signal Vslope may be dependent on a differential inductor voltage Vl, the second amplification coefficient Ksense, the inductance L of the inductor, a current rise time ton, and a dynamic duty cycle DD that is dependent on the reference voltage Vref, the input voltage Vin and the error voltage Verror1. The relationship between the parameters may be as follows, by rewriting equation (1):

$$V ( ton ) = Vslope = \frac{Vl \times Ksense}{L} \times \frac{D D}{1 - D D} \times ton \qquad ( 4 )$$

The slope generation module 604 may generate the slope compensation signal Vslope, in accordance with equation (4).

The dynamic duty cycle DD may be written as follows:

$$DD = \frac{Vref}{Vin} + Verror 2 \qquad ( 5 )$$

The amplified voltage error signal Verror2 may be written as follows:

$$Verror 2 = Kvdyn \times Verror 1 \qquad ( 6 )$$

where Kvdyn is the first amplification coefficient.

The main expression describing the current control method with slope compensation is as follows:

$$Il \times Ksense + Vslope = Kvdyn \times Verror 1 \qquad ( 7 )$$

where Il is the current I1 as illustrated in FIG. 6, and Ksense is the second amplification coefficient.

For constant first amplification coefficient Kvdyn, second amplification coefficient Ksense, and current Il, the addition of slope compensation Vslope will result in a increase in the error voltage Verror1.

To compensate for the increasing error voltage Verror1, embodiments of the present disclosure enable the first amplification coefficient Kvdyn to be variable. For example, the first amplification coefficient may be dependent on the differential inductor voltage Vl and the dynamic duty cycle DD, for example, as follows:

$$Kvdyn = Kv + Vl \times Kn \times \frac{DD}{1 - DD} \qquad ( 8 )$$

where Kv is a base expression of the amplification coefficient, and Kn is a normalising coefficient.

Equation (8) describes the state of the signals at the inputs of the comparator 618 at the switching instant, and may be referred to as the “command law” for the controller.

The differential voltage on the inductor Vl, may be calculated if the input and output voltage are known. The differential inductor voltage Vl may be calculated with an error that is compensated for. The system may be implemented as a behavioural model or in the digital domain in the form of synthesized code, for the determination of the differential inductor voltage Vl.

In summary, the present embodiment relates to a digital slope compensation apparatus for a switched-mode power supply that uses dynamic slope compensation and a dynamic gain coefficient. A sensor used for sensing an inductor current of the switched-mode power supply, a comparator is used for generating a trigger signal according to a comparison of the error between the output voltage and the reference voltage and the inductor current, and a pulse width modulator is used for controlling the operation of a switched-mode power supply, wherein the pulse width modulator is arranged to be triggered by the trigger signal of the comparator. The use of dynamic slope compensation and a dynamic gain coefficient provides improvements over known systems.

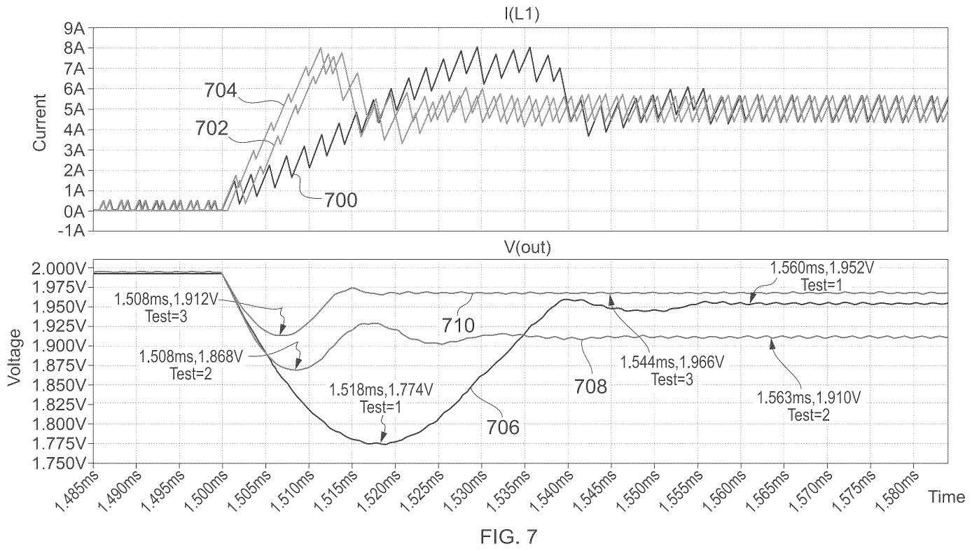

FIG. 7 is a timing graph showing simulation results for practical implementations of pulsed power supplies with static slope compensation (for example as shown in FIG. 3), for dynamic slope compensation (for example as shown in FIG. 4), and for dynamic slope compensation and dynamic amplification coefficient (for example as shown in FIG. 6). The reference voltage Vref is 2V, the over current protection is 8 A, and the load is 5 A.

There is shown an inductor current for the system using static slope compensation (a trace 700), an inductor current for the system using dynamic amplification coefficient (a trace 702), an inductor current for the system using dynamic slope compensation and dynamic amplification coefficient (a trace 704), an output voltage for the system using static slope compensation (a trace 706), an output voltage for the system using dynamic amplification coefficient (a trace 708), an output voltage for the system using dynamic slope compensation and dynamic amplification coefficient (a trace 710).

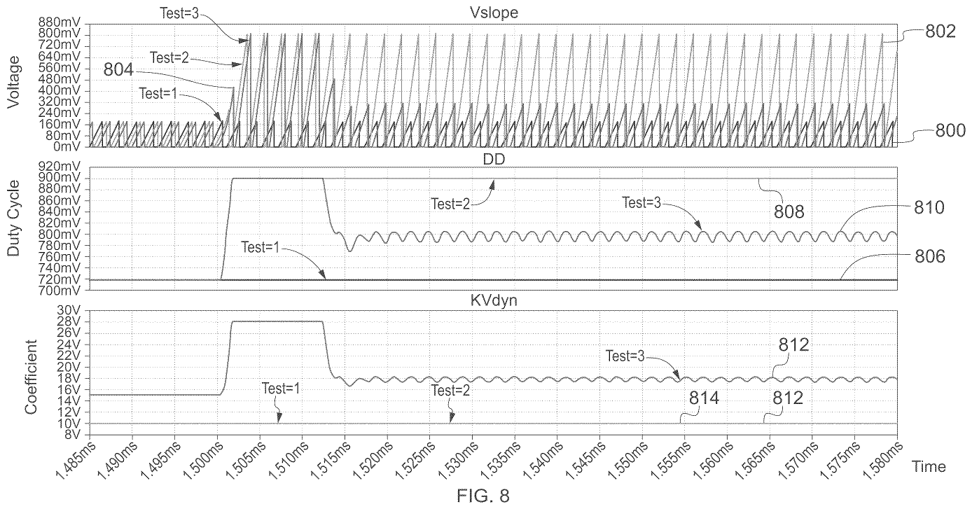

FIG. 8 is a further timing graph showing simulation results for practical implementations of pulsed power supplies with static slope compensation (for example as shown in FIG. 3), for dynamic slope compensation (for example as shown in FIG. 4), and for dynamic slope compensation and dynamic amplification coefficient (for example as shown in FIG. 6).

There is shown: the slope compensation signal Vslope for the system using static slope compensation (a trace 800), the slope compensation signal Vslope for the system using dynamic amplification coefficient (a trace 802), the slope compensation signal Vslope for the system using dynamic slope compensation and dynamic amplification coefficient (a trace 804), the dynamic duty cycle DD for the system using static slope compensation (a trace 806), the dynamic duty cycle DD for the system using dynamic amplification coefficient (a trace 808), the dynamic duty cycle DD for the system using dynamic slope compensation and dynamic amplification coefficient (a trace 810), the first amplification coefficient Kvdyn for the system using static slope compensation (a trace 812), the first amplification coefficient Kvdyn for the system using dynamic amplification coefficient (a trace 814), the first amplification coefficient Kvdyn for the system using dynamic slope compensation and dynamic amplification coefficient (a trace 816).

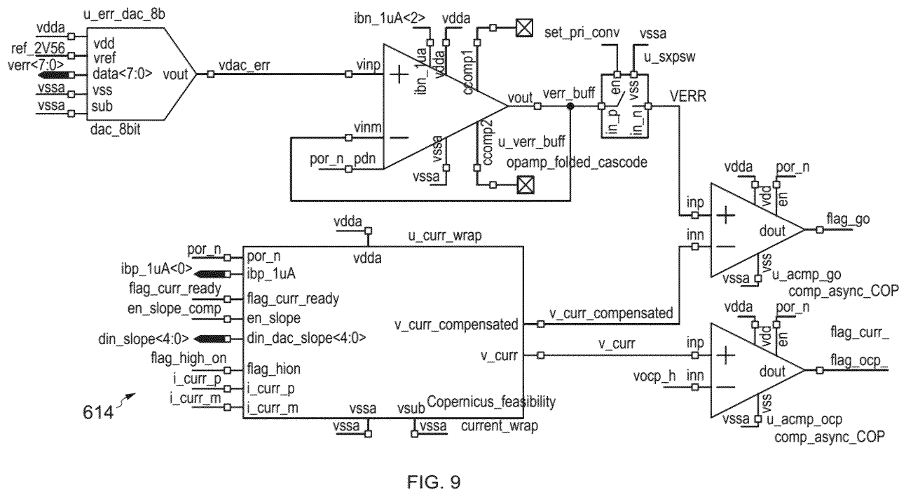

FIG. 9 is a schematic of a specific embodiment of the dynamic gain module 614. In a specific embodiment, the first amplification coefficient KVdyn may be calculated by digital methods in a digital unit of the switch-mode power supply. In the digital unit the error value Verror1 is multiplied by the dynamic gain coefficient (KVdyn), as represented by equation (6), and then the finished result Verror2 is output to a digital to analog converter (DAC), then the output of the DAC goes to the comparator 618.

For embodiments of the present disclosure dynamic slope compensation provides improved load response and over-all output regulation over a wide load range as compared to known slope compensation methods such as presented in FIG. 3. Known slope compensation techniques employ a current compensation bias with a fixed slope over the entire operating range (duty cycle>50%). Embodiments of the present disclosure may use dynamic slope compensation, which may use an adaptive current compensation bias with a variable slope.

Embodiments of the present disclosure provide improvement through reduction of such parameters as: time response, transient voltage drop and error of the output voltage relative to the reference voltage.

Embodiments of the present disclosure use dynamic slope compensation together with a dynamic amplification coefficient. Dynamic slope compensation may be provided by adding an additional component to the calculation of the slope compensation function, that is proportional to the error of output voltage relative to the reference voltage. The dynamic amplification coefficient may be provided by generating an error in the output voltage relative to the reference voltage to make variable by the same law as provided for dynamic slope compensation. The combination of dynamic slope compensation and dynamic gain coefficient may be used to accelerate load response and reduce error of the output voltage in systems which work with duty cycles more than 50%.

Dynamic slope compensation adaptively adjusts the slope compensation signal, the resulting duty cycle of the converter will differ from prior art solutions. To determine if a converter is practicing the invention, connect the converter to a variable load. Increase the load in incremental steps and record the duty cycle of the power stage. Pay particular attention to the load settings that result in duty cycles greater than 50%. Based on these duty cycle measurements, it can be determined if the slop compensation signal plus dynamic gain control is a fixed or variable slope. If it is determined to be variable beyond what would normally be associated with slope compensation only, the converter is practicing dynamic slope compensation.

Common reference numerals and variable between figures represent common features. Various improvements and modifications may be made to the above without departing from the scope of the disclosure.

1. A current mode controller for a switching converter comprising one or more power switches, an energy storage element, and being configured to receive an input voltage and to generate an output voltage, the current mode controller comprising:
an error voltage generator configured to generate an error voltage that is dependent on the output voltage and a reference voltage;
a current sensing module configured to:
sense a current that is flowing through the energy storage element,
receive the error voltage, and
generate a slope compensated sensed current signal that is dependent on the sensed current and the error voltage;
an error amplifier configured to:
receive the error voltage, and
generate an amplified voltage error signal by applying a first amplification coefficient to the error voltage, the first amplification coefficient being dependent on the error voltage; and
a control signal generator configured to generate one or more control signals to control the switching operation of the one or more power switches of the switching converter, each of the one or more control signals being dependent on the slope compensated sensed current signal and the amplified voltage error signal.

2. The current mode controller of claim 1, wherein the energy storage element comprises an inductor.

3. The current mode controller of claim 1, wherein the current mode controller is configured to provide peak current control.

4. The current mode controller of claim 1, wherein the error voltage generator comprises a subtractor circuit configured to generate the error voltage by subtracting the reference voltage from the output voltage or by subtracting the output voltage from the reference voltage.

5. The current mode controller of claim 1, wherein the current sensing module comprises a current sensing amplifier configured to:
sense the current that is flowing through the energy storage element; and
generate an amplified sensed current signal by applying a second amplification coefficient to the sensed current;
wherein the slope compensated sensed current signal is dependent on the amplified sensed current signal, thereby being dependent on the sensed current.

6. The current mode controller of claim 5, wherein the current sensing module comprises a slope generation module configured to:
receive the error voltage; and
generate a slope compensation signal that is dependent on the error voltage;
wherein the slope compensated sensed current signal is dependent on the slope compensation signal, thereby being dependent on the error voltage.

7. The current mode controller of claim 6, wherein:
the energy storage element comprises an inductor; and
the slope compensation signal is dependent on
a differential inductor voltage;
the second amplification coefficient;
the inductance of the inductor;
a current rise time; and
a dynamic duty cycle that is dependent on the reference voltage, the input voltage and the error voltage.

8. The current mode controller of claim 6, wherein the current sensing module comprises an addition circuit configured to:
generate the slope compensated sensed current signal by adding the slope compensation signal and the amplified sensed current signal; and
provide the slope compensated sensed current signal to the control signal generator.

9. The current mode controller of claim 8, wherein the slope compensation signal is added to the amplified sensed current signal by adding a bias current to the amplified sensed current signal.

10. The current mode controller of claim 1, wherein the error amplifier comprises a dynamic gain module configured to:
receive the error voltage; and
generate the first amplification coefficient using the error voltage.

11. The current mode controller of claim 10, wherein:
the energy storage element comprises an inductor; and
the first amplification coefficient is dependent on:
a differential inductor voltage; and
a dynamic duty cycle that is dependent on the reference voltage, the input voltage and the error voltage.

12. The current mode controller of claim 10, wherein the error amplifier comprises a voltage error amplifier module configured to:
receive the error voltage;
receive the first amplification coefficient from the dynamic gain module; and
generate the amplified voltage error signal by applying the first amplification coefficient to the error voltage.

13. The current mode controller of claim 1, wherein the control signal generator comprises:
a comparator configured to:
receive the slope compensated sensed current signal at a first input terminal,
receive the amplified voltage error signal at a second input terminal, and
generate a comparator output signal at an output terminal, the comparator output signal being dependent on the comparison between the sensed current signal and the amplified voltage error signal; and
a pulse width modulator circuit configured to:
receive the comparator output signal, and
generate the one or more control signals using the comparator output signal.

14. The current mode controller of claim 1, wherein:
a duty cycle is approximately equal to the reference voltage divided by the input voltage;
for the duty cycle being greater than or approximately equal to 50%,
the current sensing module is configured to:
sense the current that is flowing through the energy storage element,
receive the error voltage, and
generate the slope compensated sensed current signal that is dependent on the sensed current and the error voltage; and
the control signal generator is configured to:
generate the one or more control signals to control the switching operation of the one or more power switches of the switching converter, each of the one or more control signals being dependent on the slope compensated sensed current signal and the amplified voltage error signal; and
for the duty cycle being less than 50%,
the current sensing module is configured to:
sense the current that is flowing through the energy storage element, and
generate a sensed current signal that is dependent on the sensed current; and
the control signal generator is configured to:
generate the one or more control signals to control the switching operation of the one or more power switches of the switching converter, each of the one or more control signals being dependent on the sensed current signal.

15. The controller of claim 1, wherein the switching converter is a buck converter, a boost converter or a buck-boost converter.

16. A switched-mode power supply comprising:
a switching converter configured to receive an input voltage and to generate an output voltage,
the switching converter comprising:
one or more power switches;
an energy storage element; and
a current mode controller comprising:
an error voltage generator configured to generate an error voltage that is dependent on the output voltage and a reference voltage;
a current sensing module configured to:
sense a current that is flowing through the energy storage element;
receive the error voltage; and
generate a slope compensated sensed current signal that is dependent on the sensed current and the error voltage;
an error amplifier configured to:
receive the error voltage; and
generate an amplified voltage error signal by applying a first amplification coefficient to the error voltage, the first amplification coefficient being dependent on the error voltage; and
a control signal generator configured to generate one or more control signals to control the switching operation of the one or more power switches of the switching converter, each of the one or more control signals being dependent on the slope compensated sensed current signal and the amplified voltage error signal.

17. The switched-mode power supply of claim 16, wherein the energy storage element comprises an inductor.

18. The switched-mode power supply of claim 16, wherein the current mode controller is configured to provide peak current control.

19. The switched-mode power supply of claim 16, wherein the switching converter is a buck converter, a boost converter or a buck-boost converter.

20. A method of controlling a switching converter comprising one or more power switches, an energy storage element, and being configured to receive an input voltage and to generate an output voltage, the method comprising:
generating an error voltage that is dependent on the output voltage and a reference voltage, using an error voltage generator;
sensing a current that is flowing through the energy storage element using a current sensing module;
receiving the error voltage at the current sensing module;
generating a slope compensated sensed current signal that is dependent on the sensed current and the error voltage using the current sensing module;
receiving the error voltage at an error amplifier;
generating an amplified voltage error signal by applying a first amplification coefficient to the error voltage using the error amplifier, the first amplification coefficient being dependent on the error voltage;
generating one or more control signals using a control signal generator, each of the one or more control signals being dependent on the slope compensated sensed current signal and the amplified voltage error signal; and
controlling the switching operation of the one or more power switches using the one or more control signals.
